(19) United States
(12) Patent Application Publication
(10) Pub. No.: US 2010/0288417 A1
(43) Pub. Date: Nov. 18, 2010

(54) BONDING METHOD AND BONDING APPARATUS

(75) Inventor: Kazuhisa Mishima, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/780,228

(22) Filed: May 14, 2010

(30) Foreign Application Priority Data
May 15, 2009 (JP) 2009-118607

(51) Int. Cl. B32B 37/12; B32B 37/02

(52) U.S. Cl. 156/60; 156/538

(57) ABSTRACT

A bonding method for bonding a pair of substrates together with an adhesive, the bonding method includes placing the adhesive between the substrates, applying pressure to the substrates, and rotating the substrates at a first rotation speed after start of the applying pressure.

### CROSS-REFERENCE TO RELATED APPLICATIONS

This application is based upon and claims the benefit of priority of the prior Japanese Patent Application No. 2009-118607, filed on May 15, 2009, the entire contents of which are incorporated herein by reference.

### FIELD

The embodiments discussed herein are related to bonding apparatuses.

### BACKGROUND

Panel- or sheet-like substrates are bonded together with an adhesive. For example, when flexible liquid-crystal display panels, typified by electronic paper sheets, are to be bonded together, or when a functional substrate, such as an ultraviolet protection film, is to be bonded to a liquid-crystal display panel, an optical adhesive is generally used in the bonding process. To ensure display quality, it is important to eliminate air bubbles in the bonding process. Therefore, bonding methods which do not allow many air bubbles to remain or which allow removal of air bubbles are used to bond substrates together with an adhesive.

Japanese Laid-open Patent Publication No. 6-180864 discloses a bonding method in which panels to be bonded together are mounted on their corresponding plates with high flatness, an adhesive is applied to one of the panels, and pressure is applied to the panels at a speed which allows the adhesive to spread uniformly. FIG. 1A and FIG. 1B are diagrams for describing this bonding method which involves application of pressure.

As illustrated in FIG. 1A, a first panel 1 and a second panel 2 to be bonded together are mounted, by suction, on a lower pressure plate 3 and an upper pressure plate 4, respectively. After an adhesive 5 is placed at the center of the first panel 1, the upper pressure plate 4 is pressed toward the lower pressure plate 3, as illustrated in FIG. 1B. The resulting pressure causes the adhesive 5 to spread over the entire area where the two panels 1 and 2 face each other.

Japanese Laid-open Patent Publication No. 63-18326 discloses a bonding method which uses centrifugal force of rotation to positively remove air bubbles. FIG. 2A and FIG. 2B are diagrams for describing this bonding method which involves use of centrifugal force of rotation.

As illustrated in FIG. 2A, a first panel 1 is mounted on a rotating table 7, an adhesive 5 is placed on the upper side of the first panel 1, and a second panel 2 is placed over the adhesive 5. Then, the rotating table 7 is rotated. The rotation of the rotating table 7 causes centrifugal force to act on the adhesive 5. This centrifugal force causes the adhesive 5 to flow toward the outer edges of the panels 1 and 2, so that the adhesive 5 is spread over the entire area where the panels 1 and 2 face each other.

In the bonding method which involves application of pressure (see FIG. 1A and FIG. 1B), when the amount of the adhesive 5 is increased, air bubbles 6 are moved along with the adhesive 5, which is moved (or spread) outward by application of pressure thereto. As a result, the air bubbles 6 are removed through the outer edges of the panels 1 and 2, along with excess adhesive. It is thus possible to prevent the air bubbles 6 from remaining between the panels 1 and 2.

In this bonding method, however, it takes a very long time to apply the adhesive 5 over the entire area where the panels 1 and 2 face each other. For example, when the panels 1 and 2 are A4-size panels, it takes about 180 seconds to spread the adhesive 5 such that no air bubbles 6 are left. Additionally, when the amount of adhesive 5 applied is reduced, the adhesive 5 does not spread at a uniform speed over the space between the panels 1 and 2. As a result, the remaining portions of the space may cause formation of air bubbles, which cannot be easily removed.

With the bonding method which uses centrifugal force of rotation (see FIG. 2A and FIG. 2B), it is possible to allow large air bubbles to escape to the outside. However, small air bubbles tend to move inwardly and it is very difficult to remove them.

Additionally, in this bonding method, when the panels 1 and 2 are flexible substrates, a center portion swells as illustrated in FIG. 2B. This means that a thickness H2 at the center portion is greater than a thickness H1 at an outer edge (H2>H1). For example, when an adhesive having a viscosity of 20 mPa·s is used as the adhesive 5, a difference in thickness between the rotation center and the outer edge (H2−H1) is about 3 μm to 5 μm. The adhesive 5 thus tends to swell at the center. Therefore, with this bonding method, it is difficult to ensure a uniform thickness of the adhesive 5.

### SUMMARY

An embodiment entails a bonding method for bonding a pair of substrates together with an adhesive, the bonding method includes placing the adhesive between the substrates, applying pressure to the substrates, and rotating the substrates at a first rotation speed after start of the applying pressure.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A and FIG. 1B are diagrams for describing a known bonding method.

FIG. 2A and FIG. 2B are diagrams for describing another known bonding method.

FIG. 3 is a diagram for describing a bonding apparatus and a bonding method using the bonding apparatus, according to a first embodiment.

FIG. 4 is another diagram for describing the bonding apparatus and the bonding method according to the first embodiment.

FIG. 5 is another diagram for describing the bonding apparatus and the bonding method according to the first embodiment.

FIG. 6 is another diagram for describing the bonding apparatus and the bonding method according to the first embodiment.

FIG. 7 is another diagram for describing the bonding apparatus and the bonding method according to the first embodiment.

FIG. 8 is a graph showing a relationship between a rotation speed and the amount of press-in.

FIG. 9A and FIG. 9B are diagrams for describing a method for preventing an adhesive from sticking to electrode terminals of panels.

FIG. 10 is a diagram for describing a bonding apparatus and a bonding method using the bonding apparatus, according to a second embodiment.

FIG. 11 is another diagram for describing the bonding apparatus and the bonding method according to the second embodiment.

FIG. 12 is another diagram for describing the bonding apparatus and the bonding method according to the second embodiment.

FIG. 13 is another diagram for describing the bonding apparatus and the bonding method according to the second embodiment.

FIG. 14 is another diagram for describing the bonding apparatus and the bonding method according to the second embodiment.

FIG. 15 is another diagram for describing the bonding apparatus and the bonding method according to the second embodiment.

### DESCRIPTION OF EMBODIMENTS

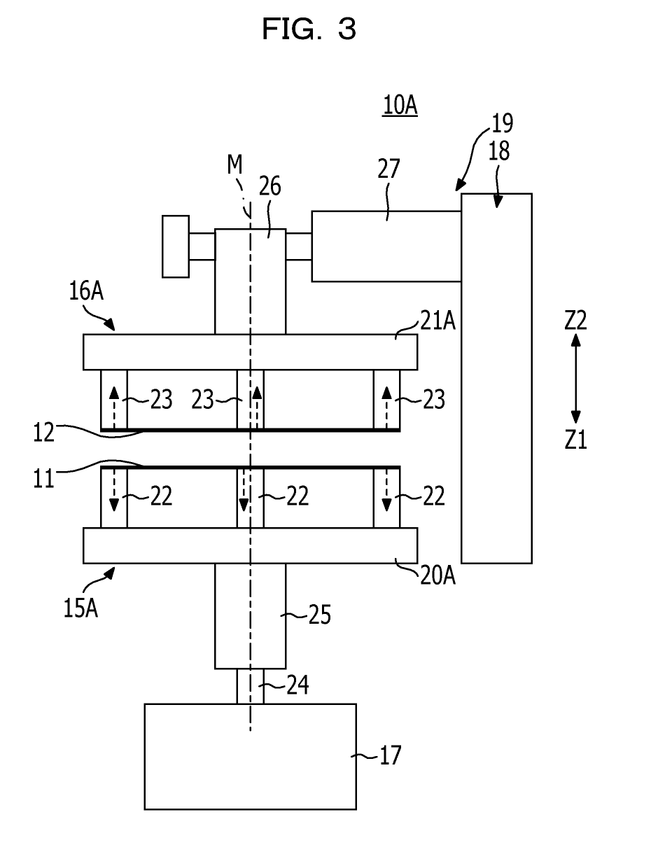

FIG. 3 to FIG. 7 are diagrams for describing a bonding apparatus and a bonding method using the bonding apparatus, according to a first embodiment. In the present embodiment, a description is given of the bonding method and apparatus with which a first panel 11 and a second panel 12 are bonded together with an adhesive 30. The first and second panels 11 and 12 may both be flexible liquid-crystal display panels, typified by electronic paper sheets. Alternatively, one of the first and second panels 11 and 12 may be such a liquid-crystal display panel and the other may be a functional substrate, such as an ultraviolet protection film. The following embodiments are concerned with the case where both the first and second panels 11 and 12 are flexible liquid-crystal display panels.

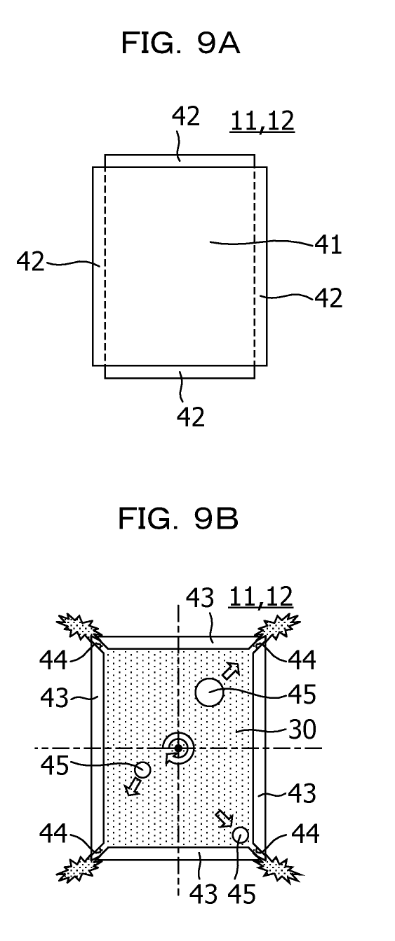

FIG. 9A illustrates the first and second panels 11 and 12 (or may be collectively referred to as panels 11 and 12). As illustrated in FIG. 9A, the panels 11 and 12 have electrode terminals 42 around the respective four outer edges of a liquid-crystal display area 41.

The electrode terminals 42 are to be connected to an external connection substrate. If the adhesive 30 sticks to the electrode terminals 42, a poor connection with the external connection substrate may occur. Therefore, as illustrated in FIG. 9B, in the present embodiment, sealing walls 43 are provided on the respective electrode terminals 42 to prevent the adhesive 30 from sticking to the electrode terminals 42.

Additionally, as illustrated in FIG. 9B, since the electrode terminals 42 are not provided at the four corners of the panels 11 and 12, adhesive outlets 44 are formed at the corresponding positions. When the panels 11 and 12 are rotated as described below, excess adhesive 30 is discharged, along with air bubbles 45, through the adhesive outlets 44 to the outside of the panels 11 and 12.

The thickness of the sealing walls 43 is set depending on the thickness of the adhesive 30 placed between the panels 11 and 12. The sealing walls 43 may be provided on both or one of the panels 11 and 12. Again, this is determined depending on the thickness of the adhesive 30 placed between the panels 11 and 12.

Referring to FIG. 3, a bonding apparatus 10A of the first embodiment will now be described. The bonding apparatus 10A includes a lower mount 15A, an upper mount 16A, a motor 17, and a pressure device 19.

The lower mount 15A includes a lower base 20A and lower panel sucking members 22. The first panel 11 is mounted on the lower mount 15A. The lower base 20A is a disk-shaped base, under which a connecting unit 25 is disposed. The connecting unit 25 is connected to a rotating shaft 24 of the motor 17. Therefore, the lower mount 15A is rotated by being driven by the motor 17.

The lower panel sucking members 22 are disposed on the lower base 20A. The lower panel sucking members 22 are positioned at a center of a mounting position of the first panel 11 and also outside the center. In the present embodiment, all the lower panel sucking members 22 have the same configuration and thus have the same height from the lower base 20A.

The lower panel sucking members 22 are connected to a vacuum suction device (not shown). An end of each of the lower panel sucking members 22 is configured to suck the first panel 11. The first panel 11 is mounted on the lower mount 15A by being sucked by the lower panel sucking members 22.

The upper mount 16A includes an upper base 21A and upper panel sucking members 23. The second panel 12 is mounted on the upper mount 16A. The upper base 21A is a disk-shaped base, on which a rotary driven unit 26 is disposed.

The rotary driven unit 26 is attached to a lifting and lowering arm 27 which is a constituent element of the pressure device 19. The rotary driven unit 26 serves as a bearing that rotatably supports the upper mount 16A relative to the lifting and lowering arm 27. In other words, the upper mount 16A is supported by the rotary driven unit 26 such that the upper mount 16A is rotatable relative to the lifting and lowering arm 27.

The upper panel sucking members 23 are disposed on the upper base 21A. The upper panel sucking members 23 are positioned at a center of a mounting position of the second panel 12 and also outside the center. In the present embodiment, all the upper panel sucking members 23 have the same configuration and thus have the same height from the upper base 21A.

As in the case of the lower panel sucking members 22, the upper panel sucking members 23 are connected to a vacuum suction device (not shown). An end of each of the upper panel sucking members 23 is configured to suck the second panel 12. The second panel 12 is mounted on the upper mount 16A by being sucked by the upper panel sucking members 23.

The pressure device 19 includes a lifting and lowering device 18 (and the lifting and lowering arm 27. As described above, the lifting and lowering arm 27 supports the upper mount 16A through the rotary driven unit 26. The lifting and lowering device 18 is capable of moving the lifting and lowering arm 27 in Z1 and Z2 directions (indicated by a two-headed arrow in the drawings) under numerical control or the like. Note that the Z1 and Z2 directions in the drawings correspond to a downward direction and an upward direction, respectively.

The lifting and lowering device 18 has an internal drive mechanism, such as a motor or a linear actuator. The lifting and lowering arm 27 moves up and down in the Z1 and Z2 directions by being driven by this drive mechanism. As described above, since the upper mount 16A is supported by the lifting and lowering arm 27 through the rotary driven unit 26, the upper mount 16A moves up and down (i.e., moves in the Z1 and Z2 directions) as the lifting and lowering arm 27 moves up and down.

Unlike the upper mount 16A, the lower mount 15A and the motor 17 are fixed in place. Therefore, when being driven by the lifting and lowering device 18, the upper mount 16A moves up and down relative to the lower mount 15A. A position at which the upper mount 16A is most distant from the lower mount 15A is set to a position which allows the panels 11 and 12 to be easily mounted on the mounts 15A and 16A, respectively, and allows the adhesive 30 to be easily placed on the first panel 11. A position at which the upper mount 16A is closest to the lower mount 15A is set to a position which allows the distance between the panels 11 and 12 to reach a “target thickness” (described below).

A description will now be given of the bonding method for bonding the first panel 11 and the second panel 12 together, through use of the bonding apparatus 10A having the configuration described above.

To bond the panels 11 and 12 together, first, the pressure device 19 moves the upper mount 16A in the Z2 direction to a position distant from the lower mount 15A. In this state, the lower panel sucking members 22 and the upper panel sucking members 23 suck the first panel 11 and the second panel 12, respectively.

Thus, the first panel 11 and the second panel 12 are mounted on the lower mount 15A and the upper mount 16A, respectively. The panels 11 and 12 are mounted such that the center of each of the panels 11 and 12 coincides with a rotation center line M (indicated by an alternate long and short dash line in the drawings) of the lower mount 15A and the upper mount 16A. FIG. 3 illustrates a state in which the first panel 11 and the second panel 12 are mounted on the lower mount 15A and the upper mount 16A, respectively.

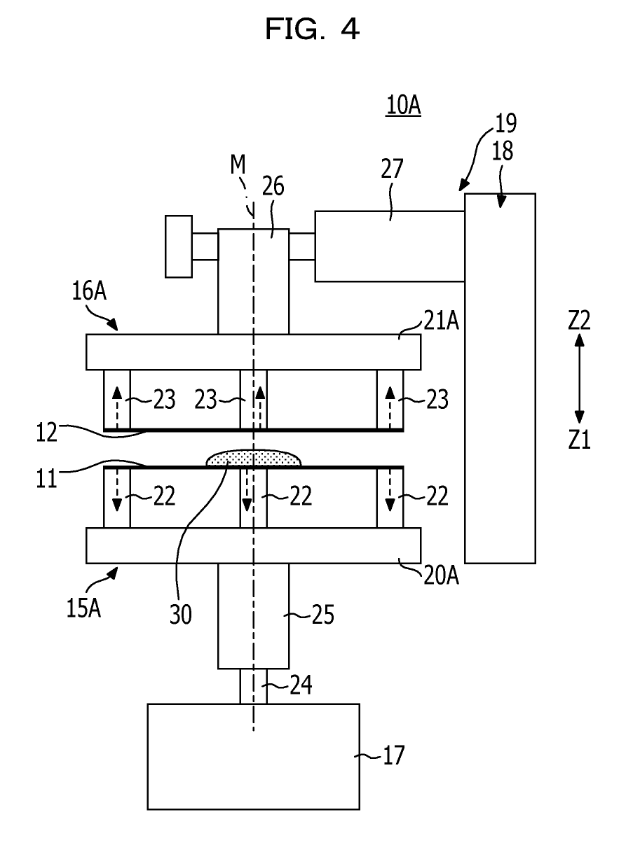

Upon completion of mounting the panels 11 and 12, the adhesive 30 is placed on the first panel 11. In the present embodiment, an adhesive having a viscosity of 20 mPa·s is used as the adhesive 30. The center of the first panel 11 (i.e., a position through which the rotation center line M passes) is selected as a position at which the adhesive 30 is placed. FIG. 4 illustrates a state after completion of placing the adhesive 30.

Upon completion of placing the adhesive 30, the pressure device 19 is activated, and the lifting and lowering device 18 lowers the lifting and lowering arm 27 (in the Z1 direction). As described above, the upper mount 16A is supported by the lifting and lowering arm 27. Therefore, as the lifting and lowering arm 27 moves downward, the upper mount 16A also moves downward (in the Z1 direction).

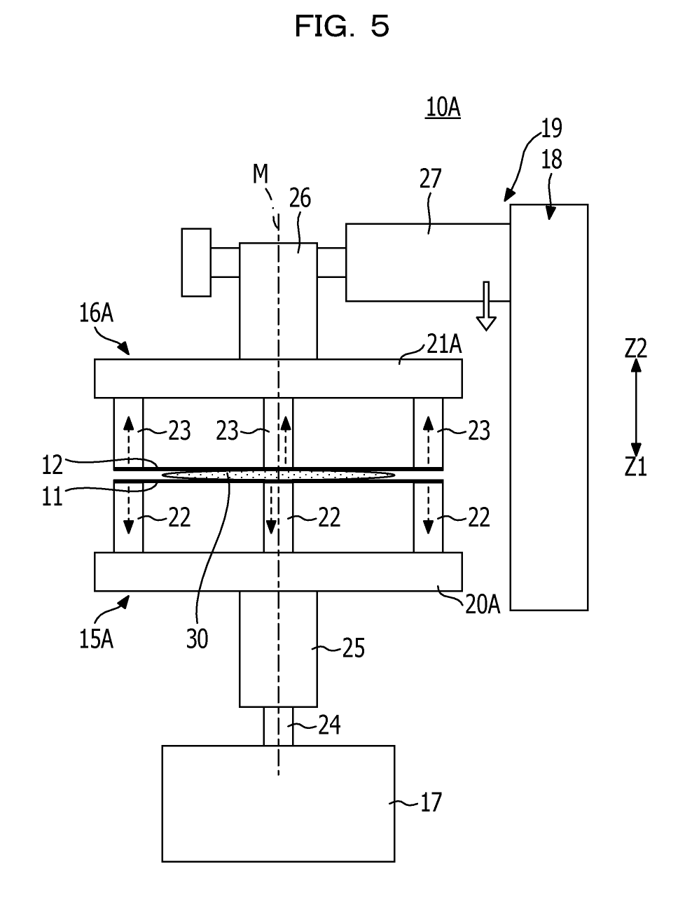

The second panel 12 comes into contact with the adhesive 30 and the upper mount 16A further moves downward, so that pressure is applied to the adhesive 30. The applied pressure causes the adhesive 30 to spread outward from the center of the panels 11 and 12. FIG. 5 illustrates a state in which downward movement of the upper mount 16A causes the second panel 12 to apply pressure to the adhesive 30, so that the adhesive 30 is spread outward.

Here, the time at which the second panel 12 comes into contact with the adhesive 30 is denoted by time T0. The amount by which the upper mount 16A is lowered after the second panel 12 comes into contact with the adhesive 30 is hereinafter referred to as the amount of press-in.

After time T0, the upper mount 16A continues to move downward. Thus, the amount of press-in gradually increases, so that the adhesive 30 flows outward (i.e., spreads outward) between the panels 11 and 12. As the adhesive 30 flows, air bubbles contained in the adhesive 30 move toward the outside of the panels 11 and 12.

After the application of pressure to the adhesive 30 is started in the course of downward movement of the upper mount 16A, the motor 17 is driven to rotate the lower mount 15A. Since the first panel 11 is sucked by the lower panel sucking members 22, the first panel 11 rotates as the lower mount 15A rotates. As described above, the upper mount 16A is supported by the rotary driven unit 26 such that the upper mount 16A is rotatable relative to the lifting and lowering arm 27, and the second panel 12 is sucked and mounted on the upper mount 16A. Additionally, the adhesive 30 is interposed between the first panel 11 and the second panel 12.

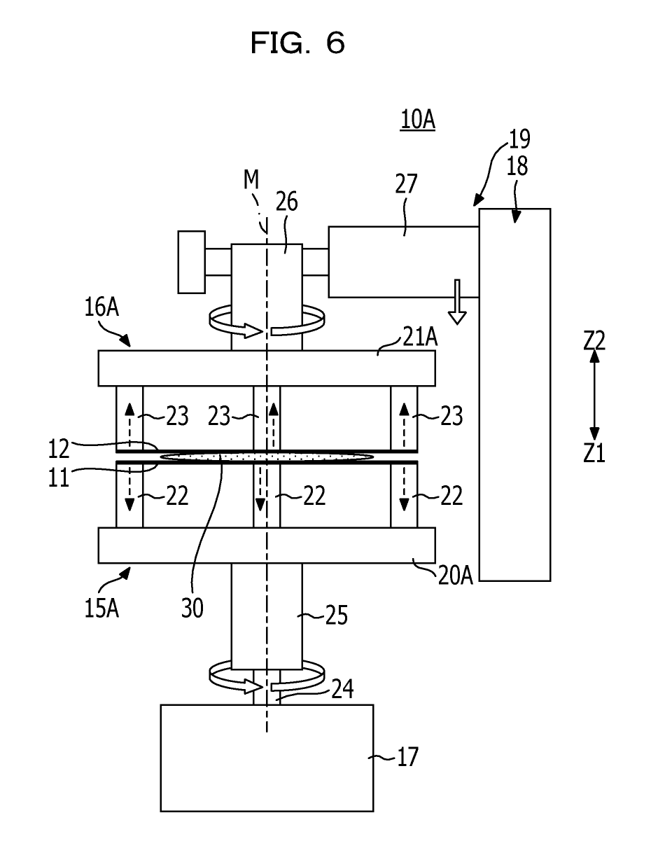

Therefore, since rotation of the lower mount 15A is transmitted to the upper mount 16A, the upper mount 16A rotates to follow the rotation of the lower mount 15A. Thus, the panels 11 and 12 are rotated by the motor 17. When the panels 11 and 12 are rotated by rotation of the motor 17, centrifugal force acts on the adhesive 30. The centrifugal force causes the adhesive 30 to move toward the outside of the panels 11 and 12. FIG. 6 illustrates a state in which the panels 11 and 12 are rotated while pressure is being applied to the adhesive 30.

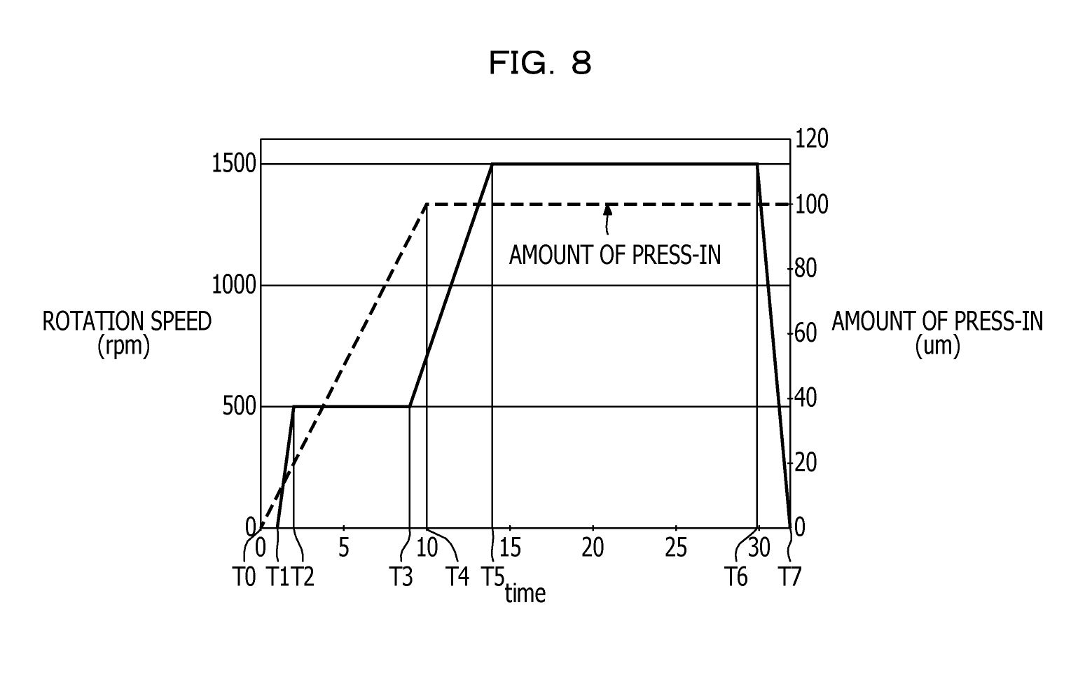

In the present embodiment, the motor 17 is activated at time T1, that is, after a lapse of a predetermined period of time from time T0. FIG. 8 is a graph showing a relationship along the time axis between the rotation speed (or revolutions per minute (rpm)) of the motor 17 and the amount of press-in, that is, the amount by which the adhesive 30 is pressed by downward movement of the upper mount 16A. As shown in FIG. 8, in the present embodiment, the motor 17 is activated at time T1, that is, after a lapse of a predetermined period of time (e.g., 1 second) from time T0. Therefore, beginning at time T1, pressure associated with downward movement of the upper mount 16A and centrifugal force associated with rotation of the mounts 15A and 16A are simultaneously applied to the adhesive 30.

After being rapidly accelerated to 500 rpm (first rotation speed), the mounts 15A and 16A (i.e., the motor 17) rotate at a constant speed of 500 rpm. That is, the rotation speed of the mounts 15A and 16A is increased to 500 rpm in about 1 second from time T1 to time T2 and is kept constant at this level.

During the period of this constant-speed rotation, the pressure device 19 still continues to move downward. This means that the amount of press-in gradually increases during this period. Therefore, during the period of this constant-speed rotation (from time T2 to time T3 in FIG. 8), the adhesive 30 is spread out mainly by pressure applied thereto by downward movement of the upper mount 16A, and centrifugal force generated by rotation of the mounts 15A and 16A acts as an auxiliary force for spreading the adhesive 30.

A speed at which the adhesive 30 is spread by downward movement of the upper mount 16A (V1) is greater than a speed at which the adhesive 30 is spread by centrifugal force generated by rotation of the motor 17 (V2) (i.e., V1>V2). It is preferable that V1 and V2 be as close as possible. In the present embodiment, the adhesive 30 has a viscosity of 20 mPa·s, the speed of downward movement of the upper mount 16A is 10 μm/s, and the rotation speed of the motor 17 is 500 rpm as described above.

When the thickness of the adhesive 30 between the panels 11 and 12 is reduced to an assumed default thickness by pressure applied by downward movement of the upper mount 16A, the rotation speed of the motor 17 is changed to 1500 rpm (second rotation speed), which is faster than 500 rpm (first rotation speed). Here, the phrase “assumed default thickness” described above means a thickness (referred to as a “default thickness”) larger than a final thickness (referred to as a “target thickness”) of the adhesive 30 obtained after completion of the bonding process. In the present embodiment, the “default thickness” and the “target thickness” are 15 μm and 10 μm, respectively.

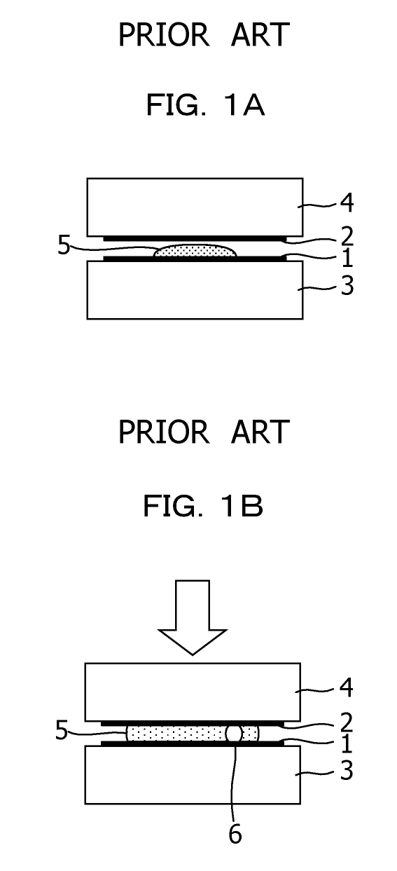

As in the case of the known bonding method which involves application of pressure (see FIG. 1A and FIG. 1B), even if the adhesive 30 is spread only by application of pressure associated with downward movement of the upper mount 16A, the adhesive 30 can be easily spread out between the panels 11 and 12 at the beginning. This is because, in the early stage of the pressure application process, the panels 11 and 12 are spaced apart and the flow resistance of the adhesive 30 is low. However, when the distance between the panels 11 and 12 falls below a predetermined value, the flow resistance of the adhesive 30 begins to increase. The distance at which the flow resistance begins to increase is referred to as the “default thickness”. If the adhesive 30 is spread only by application of pressure associated with downward movement of the upper mount 16A, the pressure application process takes a long time before the thickness of the adhesive 30 is reduced from the “default thickness” to the “target thickness”.

In contrast, in the bonding method according to the present embodiment, when the thickness of the adhesive 30 between the panels 11 and 12 reaches the “default thickness”, the rotation speed of the motor 17 is changed from 500 rpm (first rotation speed) to 1500 rpm (second rotation speed). This increases centrifugal force acting on the adhesive 30. As a result, centrifugal force generated by rotation of the mounts 15A and 16A causes the adhesive 30 to flow outward. Therefore, the method of the present embodiment makes it possible to reduce time before the thickness of the adhesive 30 is changed from the “default thickness” to the “target thickness”.

When the upper mount 16A further moves downward and the thickness of the adhesive 30 between the panels 11 and 12 reaches the “target thickness”, the pressure device 19 stops downward movement of the lifting and lowering arm 27. Since this stops downward movement of the upper mount 16A, the corresponding application of pressure to the adhesive 30 is also stopped. Referring to FIG. 8, the time at which the thickness of the adhesive 30 between the panels 11 and 12 reaches an assumed default thickness is denoted by T3, the time at which downward movement of the upper mount 16A is stopped is denoted by T4, and the time at which the rotation speed of the mounts 15A and 16A (motor 17) reaches 1500 rpm (second rotation speed) is denoted by T5.

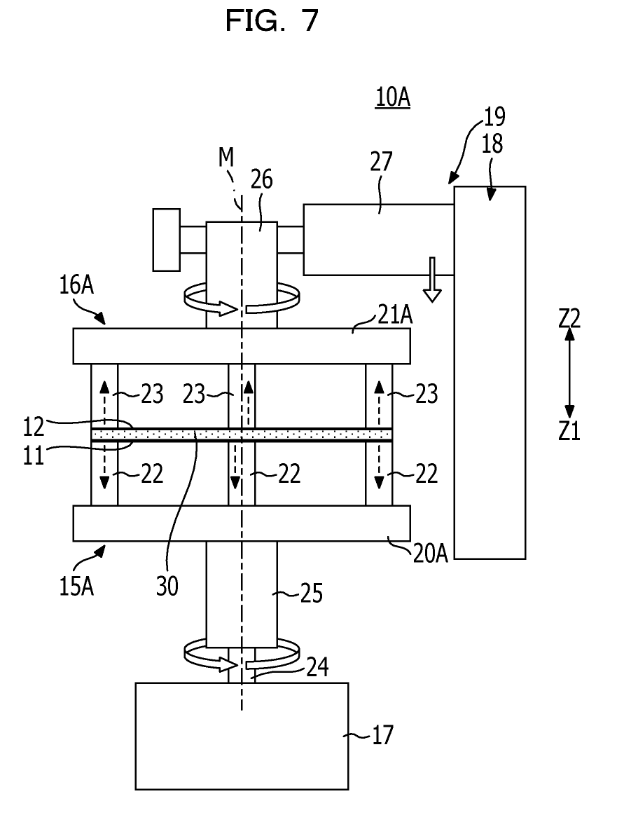

After time T4, the pressure device 19 still holds the upper mount 16A at the position which allows the distance between the panels 11 and 12 to be kept at the “target thickness”, while the motor 17 maintains its high rotation speed (1500 rpm). Therefore, the centrifugal force generated by high-speed rotation of the panels 11 and 12 causes remaining air bubbles 45 and excess adhesive 30 to move toward the outer edges of the panels 11 and 12, and to be discharged through the adhesive outlets 44 to the outside of the panels 11 and 12. It is thus possible to effectively prevent the air bubbles 45 from remaining in the adhesive 30. FIG. 7 illustrates a state in which high-speed rotation of the mounts 15A and 16A allows the adhesive 30 to be applied, with a target thickness, over the entire area where the panels 11 and 12 face each other.

After the adhesive 30 is applied with the target thickness, the motor 17 is stopped (at time T6 in FIG. 8). Then, when the rotation of the mounts 15A and 16A is completely stopped (at time T7 in FIG. 8), vacuum suction applied to each of the panel sucking members 22 and 23 is stopped. After the upper mount 16A is lifted by driving the pressure device 19, the panels 11 and 12 between which the adhesive 30 has been applied with the target thickness are taken out of the bonding apparatus 10A. Thus, through the series of operations described above, the bonding process for applying the adhesive 30 between the panels 11 and 12 is completed.

As described above, with the bonding apparatus 10A and the bonding method using the bonding apparatus 10A according to the present embodiment, the adhesive 30 can be applied with a target thickness between the panels 11 and 12 in a short time. Specifically, as compared to the cases of known methods and apparatuses where an adhesive of the same type as the adhesive 30 and panels having the same shape as that of the panels 11 and 12 are used, the time required for adhesive application can be reduced by 150 seconds, from 180 seconds (with the known methods and apparatuses) to 30 seconds (with the method and apparatus of the present embodiment). Additionally, with the method and apparatus of the present embodiment, it is possible to effectively prevent the air bubbles 45 from remaining in the adhesive 30.

Moreover, as described with reference to FIG. 9, the sealing walls 43 are provided on the electrode terminals 42 of the panels 11 and 12. At the same time, the sealing walls 43 have the adhesive outlets 44 at the four corners of the panels 11 and 12. Therefore, even when pressure and centrifugal force applied to the adhesive 30 cause it to spread out and reach the outer edges of the panels 11 and 12 (i.e., the areas where the electrode terminals 42 are formed), since the electrode terminals 42 are protected by the sealing walls 43, it is possible to prevent the adhesive 30 from sticking to the electrode terminals 42. Additionally, excess adhesive 30 is moved toward the outer edges of the panels 11 and 12 and discharged through the adhesive outlets 44 to the outside of the panels 11 and 12. Therefore, the electrode terminals 42 can be prevented from being contaminated with the adhesive 30. It is thus possible to ensure an electrical connection with improved reliability when the electrode terminals 42 are connected to other wiring.

Remaining air bubbles 45 and excess adhesive 30 are moved toward the outer edges of the panels 11 and 12 and discharged through the adhesive outlets 44 to the outside of the panels 11 and 12. Additionally, since pressure and centrifugal force are applied together to the adhesive 30 in the present embodiment, small air bubbles are pushed out to the outer edges of the panels 11 and 12 during application of pressure. Therefore, even when centrifugal force is used to perform the bonding process, it is possible to prevent air bubbles from collecting at the center of the panels 11 and 12.

A second embodiment will now be described.

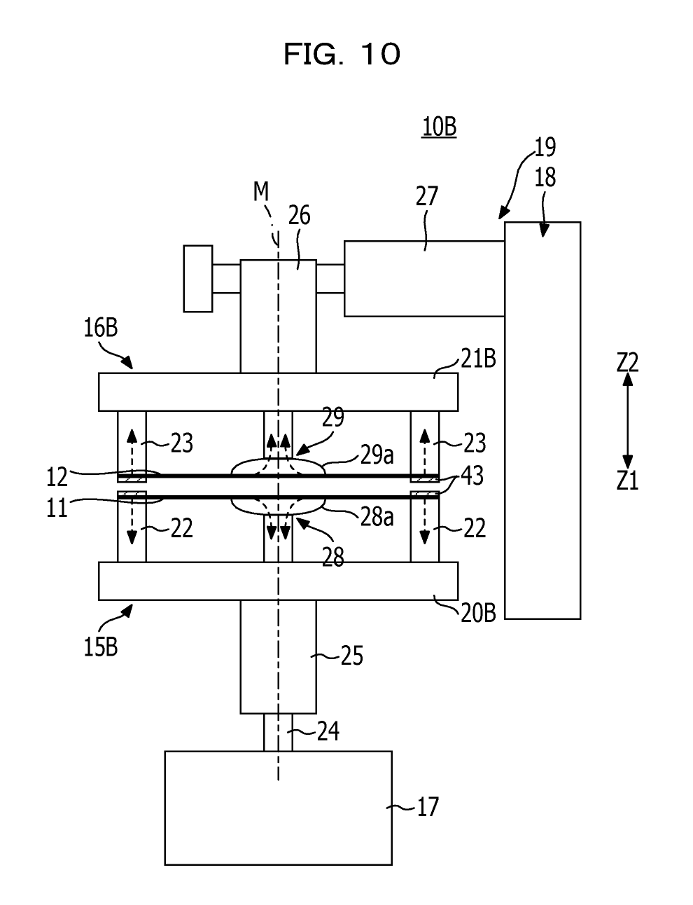

FIG. 10 to FIG. 15 are diagrams for describing a bonding apparatus 10B and a bonding method using the bonding apparatus 10B, according to the second embodiment. Referring to FIG. 10 to FIG. 15, components corresponding to those of the bonding apparatus 10A of the first embodiment illustrated in FIG. 3 to FIG. 9B are given the same reference numerals and will not be described here.

With reference to FIG. 10, the bonding apparatus 10B of the second embodiment will be described. The bonding apparatus 10B has basically the same configuration as that of the bonding apparatus 10A, except the following. In the bonding apparatus 10A of the first embodiment, the panel sucking members 22 and 23 disposed on the bases 20A and 21A of the mounts 15A and 16A, respectively, have the same configuration. However, in the bonding apparatus 10B of the second embodiment, a movable lower panel-sucking member 28 and a movable upper panel sucking member 29 (or may be collectively referred to as movable panel sucking members 28 and 29) disposed at the center have a configuration different from that of the panel sucking members 22 and 23. This will now be described in detail.

A lower mount 15B includes a lower base 20B, the lower panel sucking members 22, and a movable lower panel sucking member 28. The movable lower panel sucking member 28 is disposed at the center of the lower base 20B, while the lower panel sucking members 22 are disposed along the outside of the movable lower panel sucking member 28. The lower panel sucking members 22 are secured to the lower base 20B and have a constant height from the lower base 20B.

The movable lower panel sucking member 28 has a lifting and lowering mechanism (not shown), which allows the movable lower panel sucking member 28 to move in Z1 and Z2 directions (indicated by a two-headed arrow in the drawings) relative to the lower base 20B. Specifically, the lifting and lowering mechanism allows the movable lower panel sucking member 28 to move between a first height position and a second height position relative to the lower base 20B. The first height position is at the level of one end of the lower panel sucking members 22 remote from the lower base 20B, and the second height position is at a level lower than the first height position and closer to the lower base 20B than the first height position is to the lower base 20B. FIG. 10 illustrates a state in which the lower panel sucking members 22 and the movable lower panel sucking member 28 are level with each other relative to the lower base 20B.

The lower panel sucking members 22 and the movable lower panel sucking member 28 are connected to a vacuum suction device (not shown). Thus, an end of each of the lower panel sucking members 22 and movable lower panel sucking member 28 is configured to suck the first panel 11. The first panel 11 is mounted on the lower mount 15B by being sucked by the lower panel sucking members 22 and the movable lower panel sucking member 28. The movable lower panel sucking member 28 is provided with a sucking nozzle 28a at its end. An area where the sucking nozzle 28a sucks the first panel 11 is set to be larger than that where the lower panel sucking members 22 suck the first panel 11.

An upper mount 16B includes an upper base 21B, the upper panel sucking members 23, and the movable upper panel sucking member 29. The movable upper panel sucking member 29 is disposed at the center of the upper base 21B, while the upper panel sucking members 23 are disposed along the outside of the movable upper panel sucking member 29. The upper panel sucking members 23 are secured to the upper base 21B and have a constant height from the upper base 21B.

The movable upper panel sucking member 29 has a lifting and lowering mechanism (not shown), which allows the movable upper panel sucking member 29 to move in the Z1 and Z2 directions relative to the upper base 21B. Specifically, the lifting and lowering mechanism causes the movable upper panel sucking member 29 to move between a first height position and a second height position relative to the upper base 21B. The first height position is at the level of one end of the upper panel sucking members 23 remote from the upper base 21B, and the second height position is at a level higher than the first height position and closer to the upper base 21B than the first height position is to the upper base 21B. FIG. 10 illustrates a state in which the upper panel sucking members 23 and the movable upper panel sucking member 29 are level with each other relative to the upper base 21B.

The upper panel sucking members 23 and the movable upper panel sucking member 29 are connected to a vacuum suction device (not shown). Thus, an end of each of the upper panel sucking members 23 and movable upper panel sucking member 29 is configured to suck the second panel 12. The second panel 12 is mounted on the upper mount 16B by being sucked by the upper panel sucking members 23 and the movable upper panel sucking member 29. The movable upper panel sucking member 29 is provided with a sucking nozzle 29a at its end. An area where the sucking nozzle 29a sucks the second panel 12 is set to be larger than that where the upper panel sucking members 23 suck the second panel 12.

The lifting and lowering mechanisms described above are not limited to a particular type, as long as they can move the movable lower panel sucking member 28 and the movable upper panel sucking member 29 in the Z1 and Z2 directions. For example, they may be lifting and lowering mechanisms which use a motor or an actuator as a drive source.

A description will now be given of the bonding method for bonding the first panel 11 and the second panel 12 together, through use of the bonding apparatus 10B having the configuration described above. Again, differences with the bonding method of the first embodiment will be mainly described here, and a description of the same operations will be omitted.

To bond the panels 11 and 12 together, first, the pressure device 19 moves the upper mount 16B in the Z2 direction to a position distant from the lower mount 15B. At the same time, in the lower mount 15B, the lifting and lowering mechanism moves the movable lower panel sucking member 28 such that the movable lower panel sucking member 28 and the lower panel sucking members 22 are level with each other relative to the lower base 20B. Similarly, in the upper mount 16B, the lifting and lowering mechanism moves the movable upper panel sucking member 29 such that the movable upper panel sucking member 29 and the upper panel sucking members 23 are level with each other relative to the upper base 21B.

In this state, the lower panel sucking members 22 and the movable lower panel sucking member 28 suck the first panel 11, while the upper panel sucking members 23 and the movable upper panel sucking member 29 suck the second panel 12. As described above, the lower panel sucking members 22 and the movable lower panel sucking member 28 are level with each other, and the upper panel sucking members 23 and the movable upper panel sucking member 29 are also level with each other. Therefore, the sucked panels 11 and 12 are in a horizontal state.

Thus, the first panel 11 and the second panel 12 are mounted on the lower mount 15B and the upper mount 16B, respectively. The panels 11 and 12 are mounted such that the center of each of the panels 11 and 12 coincides with a rotation center line M (indicated by an alternate long and short dash line in the drawings) of the lower mount 15B and the upper mount 16B. FIG. 10 illustrates a state in which the first panel 11 and the second panel 12 are mounted on the lower mount 15B and the upper mount 16B, respectively.

After the panels 11 and 12 are mounted on the mounts 15B and 16B, respectively, the lifting and lowering mechanism in the lower mount 15B moves the movable lower panel sucking member 28 in the Z1 direction, and the lifting and lowering mechanism in the upper mount 16B moves the movable upper panel sucking member 29 in the Z2 direction. This operation of moving the movable lower panel sucking member 28 and the movable upper panel sucking member 29 is performed while the panels 11 and 12 are being sucked.

The panels 11 and 12 are presumably deformable, for example, the flexible liquid-crystal display panels as described above. Since the panels 11 and 12 are sucked by the panel sucking members 22 and 23, respectively, at their outer edges, the heights of these outer edges from their corresponding bases 20B and 21B are the same as the heights of their corresponding panel sucking members 22 and 23.

In this state, the center of the first panel 11 is biased by the movable lower panel sucking member 28 in the Z1 direction. When the movable lower panel sucking member 28 moves in the Z1 direction, the first panel 11 is bent downward (or in the Z1 direction) to form a bowl-like depression at the center.

Similarly, the center of the second panel 12 is biased by the movable upper panel sucking member 29 in the Z2 direction. When the movable upper panel sucking member 29 moves in the Z2 direction, the second panel 12 is bent upward (or in the Z2 direction) to form a bowl-like depression at the center.

As described above, the sucking nozzle 28a having a sucking area larger than that of the lower panel sucking members 22 is provided at one end of the movable lower panel sucking member 28, while the sucking nozzle 29a having a sucking area larger than that of the upper panel sucking members 23 is provided at one end of the movable upper panel sucking member 29. With these sucking nozzles 28a and 29a having a large sucking area, the movable panel sucking members 28 and 29 can reliably bend the panels 11 and 12, respectively. The movable panel sucking members 28 and 29 move from the levels of the ends of the panel sucking members 22 and 23, respectively, by, for example, 50 μm in the described embodiment. This means that the panels 11 and 12 are spaced apart by 100 μm at the center.

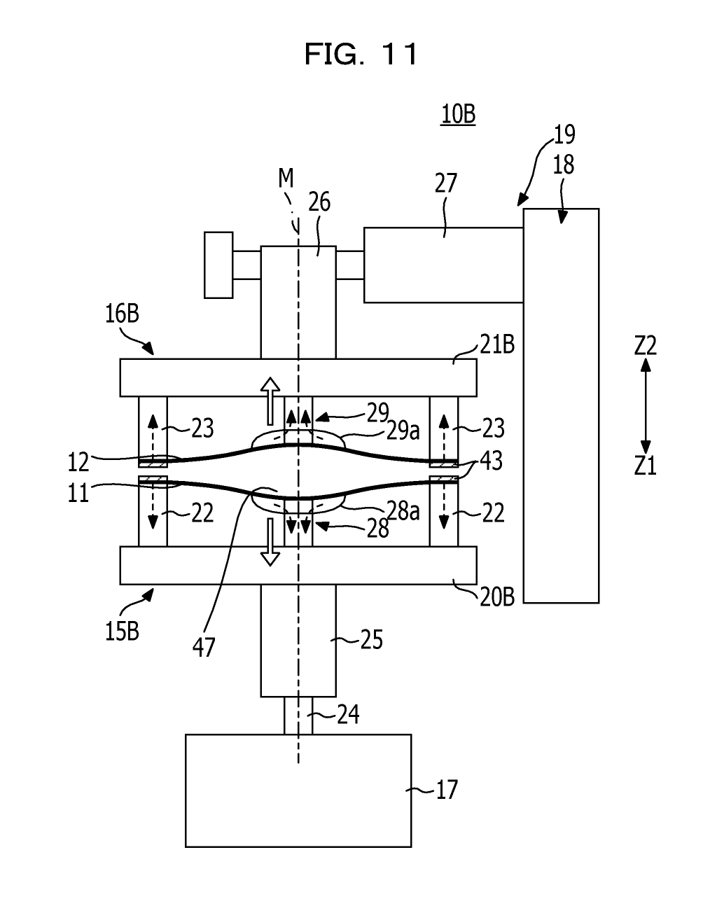

When the panels 11 and 12 are moved in the directions that separate them at their centers, a space expanded in the middle is created between the panels 11 and 12, as illustrated in FIG. 11. In the following description, this space is referred to as an adhesive space 47.

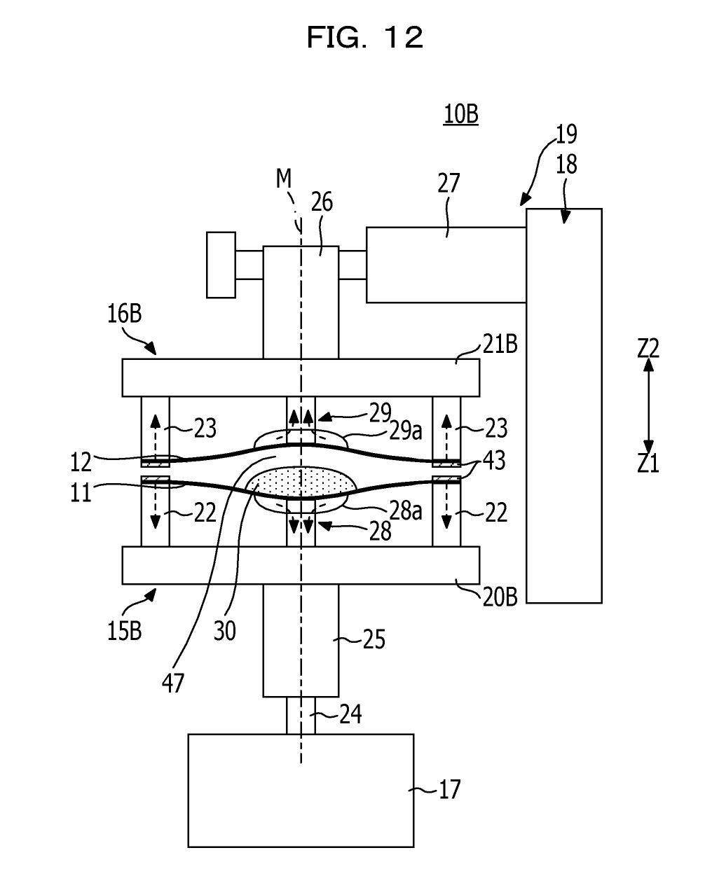

After the adhesive space 47 is created between the first panel 11 and the second panel 12 as described above, the adhesive 30 is placed in the adhesive space 47. FIG. 12 illustrates a state in which the adhesive 30 is placed in the adhesive space 47. In the present embodiment, since the panels 11 and 12 are bent at their centers in opposite directions, a larger amount of adhesive 30 can be placed between the panels 11 and 12 than that in the first embodiment.

In the present embodiment, again, an adhesive having a viscosity of 20 mPa·s is used as the adhesive 30. Since the first panel 11 is bent downward at the center, the adhesive 30 flows, under its own weight, to the center of the first panel 11 (i.e., to a position through which the rotation center line M passes).

Upon completion of placing the adhesive 30, the pressure device 19 is activated. Then, the lifting and lowering device 18 lowers the lifting and lowering arm 27, which lowers the upper mount 16B. As the upper mount 16B moves downward, the sealing walls 43 (see FIG. 9B) disposed on the electrode terminals 42 on the outer edge of the second panel 12 are brought into close contact with the sealing walls 43 disposed on the electrode terminals 42 on the outer edge of the first panel 11. Pressure is applied to the sealing walls 43 to a degree which does not cause any leakage.

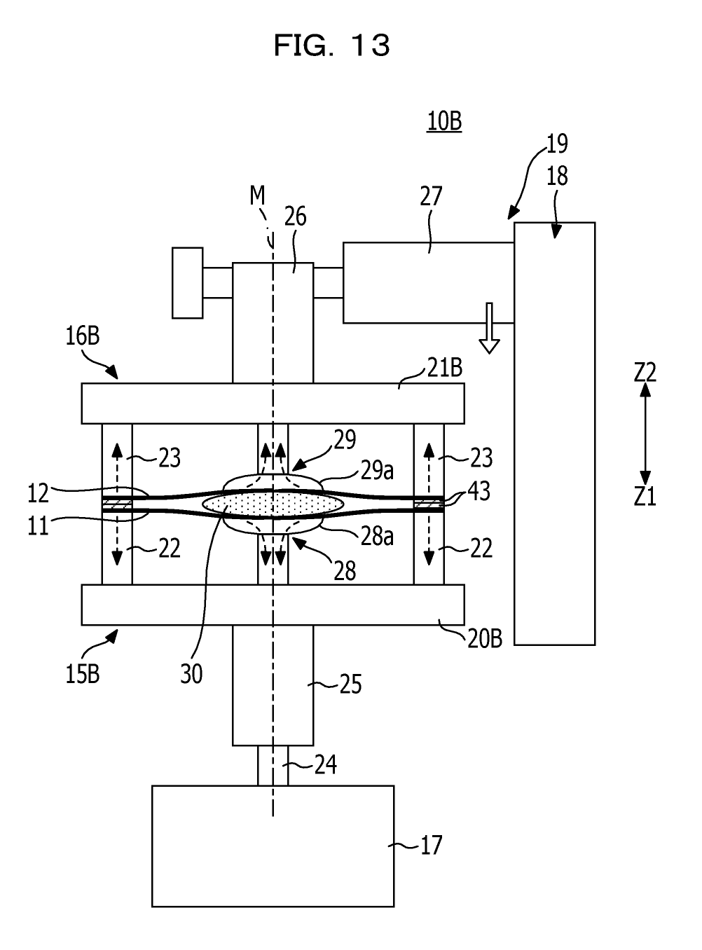

At this point, the panels 11 and 12 form a drum-shaped space in the middle where the adhesive 30 accumulates. FIG. 13 illustrates a state in which pressure is applied to the sealing walls 43 on the panels 11 and 12 to a degree which does not allow any leakage. In the present embodiment, the thickness of the sealing walls 43 during application of pressure thereto is set to be the “default thickness” of the adhesive 30.

In the lower mount 15B, the lifting and lowering mechanism moves the movable lower panel sucking member 28 upward (or in the Z2 direction) at a low speed. At the same time, in the upper mount 16B, the lifting and lowering mechanism moves the movable upper panel sucking member 29 downward (or in the Z1 direction) at a low speed. Thus, when the movable lower panel sucking member 28 and the movable upper panel sucking member 29 are moved by their lifting and lowering mechanisms in the directions that bring the movable panel sucking members 28 and 29 closer to each other, pressure is applied to the adhesive 30 between the panels 11 and 12. Then, the applied pressure causes the adhesive 30 to start to move slowly toward the outside of the panels 11 and 12.

In the present embodiment, the amount of press-in and the rotation of the motor 17 are controlled in a manner similar to that described with reference to FIG. 8. Note, however, that although the first embodiment uses the method in which the entire upper mount 16A is lowered by the pressure device 19 to apply pressure to the adhesive 30, the present embodiment uses a method in which the movable lower panel sucking member 28 and the movable upper panel sucking member 29 are moved to apply pressure to the adhesive 30.

Here, the time at which the movable panel sucking members 28 and 29 start to move and apply pressure to the adhesive 30 is denoted by T0. The total amount of movement of the movable panel sucking members 28 and 29 is referred to as the amount of press-in.

After time T0, the movable panel sucking members 28 and 29 continue to move closer to each other. Since the amount of press-in gradually increases, pressure applied to the adhesive 30 causes it to flow (or spread) outward between the panels 11 and 12. As the adhesive 30 flows, air bubbles contained in the adhesive 30 move toward the outside of the panels 11 and 12.

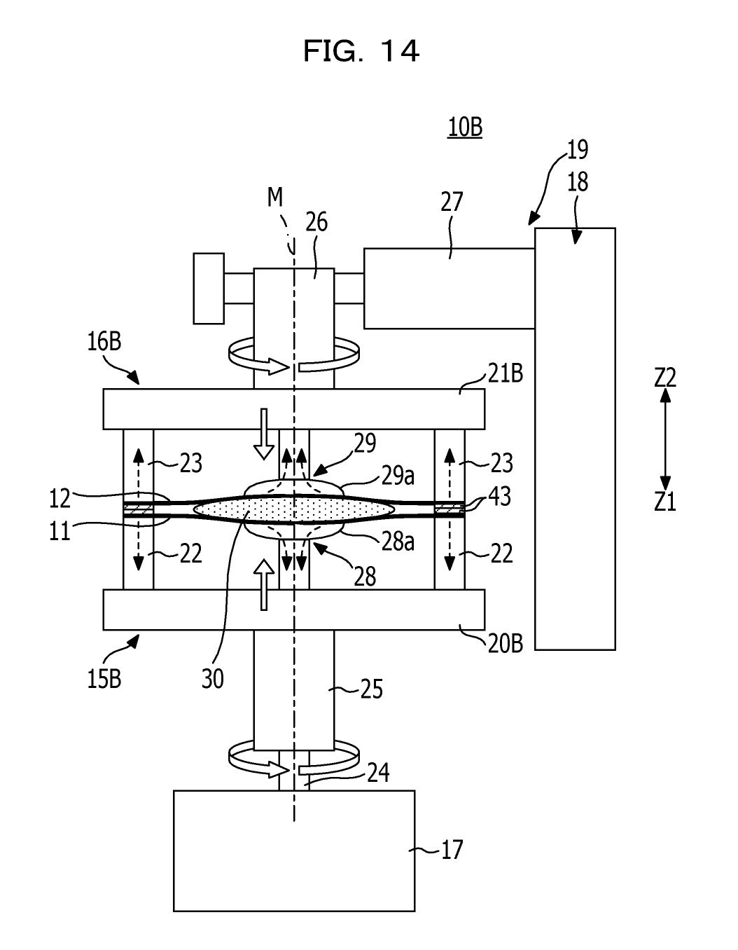

In the present embodiment, after the application of pressure to the adhesive 30 is started by movement of the movable panel sucking members 28 and 29, the motor 17 is driven to rotate the mounts 15B and 16B, so that the panels 11 and 12 are rotated. When the panels 11 and 12 are thus rotated by rotation of the motor 17, the resulting centrifugal force acts on the adhesive 30. This centrifugal force causes the adhesive 30 to move toward the outside of the panels 11 and 12. FIG. 14 illustrates a state in which the panels 11 and 12 are rotated while pressure is being applied to the adhesive 30.

In the present embodiment, again, the motor 17 is activated at time T1, that is, after a lapse of a predetermined period of time from time T0. Therefore, beginning at time T1, pressure associated with movement of the movable panel sucking members 28 and 29 and centrifugal force associated with rotation of the mounts 15B and 16B are simultaneously applied to the adhesive 30.

During the period from time T2 to time T3 in which the motor 17 rotates at a constant speed of 500 rpm, the movable panel sucking members 28 and 29 still continue to move closer to each other. This means that the amount of press-in gradually increases during the period from time T2 to time T3. Therefore, during this period, the adhesive 30 is spread out mainly by pressure applied thereto by movement of the movable panel sucking members 28 and 29, and centrifugal force acts as an auxiliary force for spreading the adhesive 30.

When the thickness of the adhesive 30 at the center of the panels 11 and 12 is reduced to the “default thickness” by pressure applied by movement of the movable panel sucking members 28 and 29, the rotation speed of the motor 17 is changed to 1500 rpm (second rotation speed), which is faster than 500 rpm (first rotation speed). This increases the amount of centrifugal force acting on the adhesive 30.

After the rotation speed of the motor 17 is changed, the adhesive 30 flows outward mainly by centrifugal force generated by rotation of the mounts 15B and 16B. Thus, the method of the present embodiment also makes it possible to reduce time before the thickness of the adhesive 30 is changed from the “default thickness” to the “target thickness”.

When the movable panel sucking members 28 and 29 further move and the thickness of the adhesive 30 at the center of the panels 11 and 12 reaches the “target thickness”, the lifting and lowering mechanisms stop the movement of the movable panel sucking members 28 and 29. Thus, the pressure applied to the adhesive 30 by the movement of the movable panel sucking members 28 and 29 is stopped.

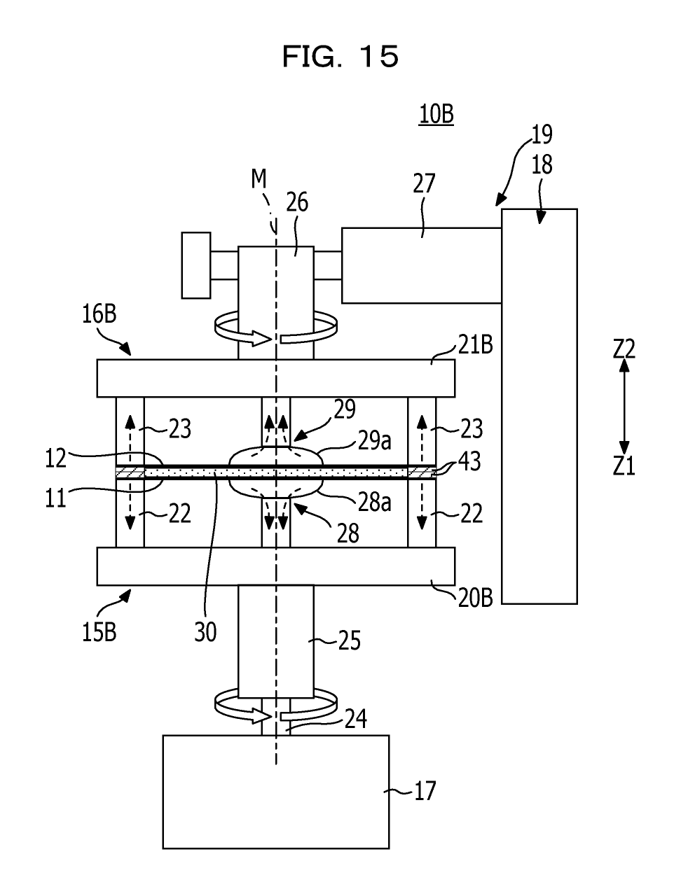

In this state, as illustrated in FIG. 15, the lower panel sucking members 22 and the movable lower panel sucking member 28 are level with each other, and the upper panel sucking members 23 and the movable upper panel sucking member 29 are also level with each other. Therefore, the sucked panels 11 and 12 are in a horizontal state. In the present embodiment, referring to FIG. 8, the time at which the thickness of the adhesive 30 between the panels 11 and 12 reaches an assumed default thickness is denoted by T3, the time at which the movement of the movable panel sucking members 28 and 29 is stopped is denoted by T4, and the time at which the rotation speed of the mounts 15B and 16B (motor 17) reaches 1500 rpm (second rotation speed) is denoted by T5.

After time T4, the motor 17 maintains its high rotation speed (1500 rpm). Therefore, the centrifugal force generated by rotation of the panels 11 and 12 causes remaining air bubbles 45 and excess adhesive 30 to move toward the outer edges of the panels 11 and 12, and to be discharged through the adhesive outlets 44 to the outside of the panels 11 and 12. It is thus possible to effectively prevent the air bubbles 45 from remaining in the adhesive 30. FIG. 15 illustrates a state in which high-speed rotation of the mounts 15B and 16B allows the adhesive 30 to be applied, with a target thickness, over the entire area where the panels 11 and 12 face each other.

After the adhesive 30 is applied with the target thickness, the motor 17 is stopped (at time T6 in FIG. 8). Then, when the rotation of the mounts 15B and 16B is completely stopped (at time T7 in FIG. 8), vacuum suction applied to each of the panel sucking members 22 and 23 and movable panel sucking members 28 and 29 is stopped. After the upper mount 16B is lifted by driving the pressure device 19, the panels 11 and 12 between which the adhesive 30 has been applied with the target thickness are taken out of the bonding apparatus 10B. Thus, through the series of operations described above, the bonding process for applying the adhesive 30 between the panels 11 and 12 is completed.

As described above, the present embodiment also makes it possible to apply the adhesive 30, with a target thickness, between the panels 11 and 12 in a short time. Additionally, since remaining air bubbles 45 and excess adhesive 30 are discharged through the adhesive outlets 44 to the outside of the panels 11 and 12, the electrode terminals 42 can be prevented from being contaminated with the adhesive 30. Also, it is possible to ensure removal of not only the excess adhesive 30, but also the air bubbles 45 contained therein.

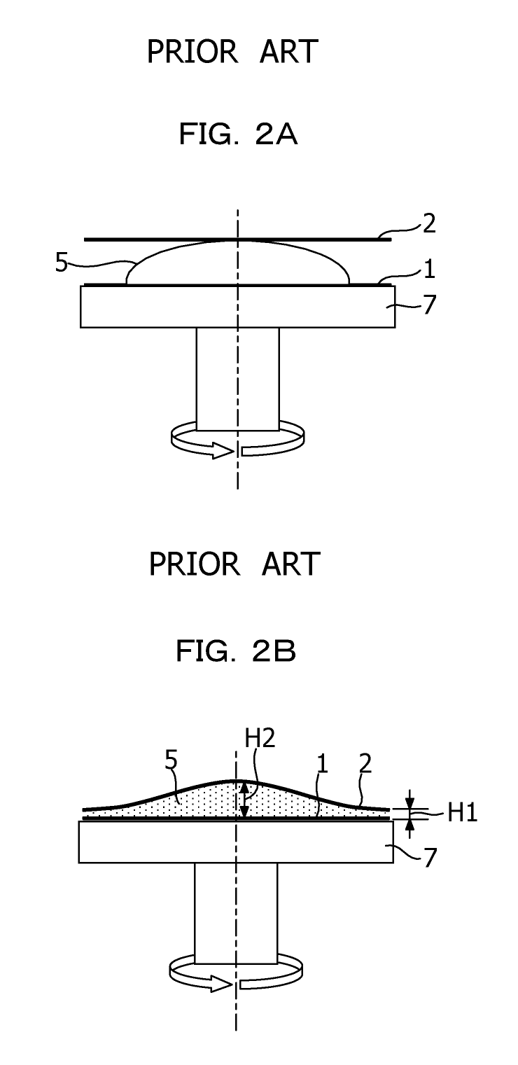

In the present embodiment, before application of pressure to the adhesive 30, the movable panel sucking members 28 and 29 are moved to create the adhesive space 47, which is obtained by expanding the middle of the panels 11 and 12. Then, after the adhesive 30 is placed in the adhesive space 47, pressure is applied to the middle of the panels 11 and 12 by moving the movable panel sucking members 28 and 29. With this method, even when the panels 11 and 12 are flexible substrates, it is possible to prevent a center portion from swelling (e.g., see FIG. 2B) after centrifugal force acts on the adhesive 30. It is thus possible to perform a high-quality bonding process which ensures a uniform thickness of the adhesive 30.

In the embodiments described above, the lower mounts 15A and 15B are fixed in place, whereas the upper mounts 16A and 16B are lifted by the pressure device 19. Alternatively, it is possible to configure such that both the lower mounts 15A and 15B and their corresponding upper mounts 16A and 16B are lifted.

The disclosed bonding methods make it possible not only to quickly apply an adhesive between substrates, but also to prevent air bubbles from remaining in the adhesive.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that various changes, substitutions, and alterations could be made hereto without departing from the spirit and scope of the invention.

1. A bonding method for bonding a pair of substrates together with an adhesive, the bonding method comprising:
placing the adhesive between the pair of substrates;
applying pressure to the pair of substrates; and
rotating the pair of substrates at a first rotation speed after start of the applying pressure.

2. The bonding method according to claim 1, wherein in the applying pressure, when a thickness of the adhesive reaches a default thickness, the first rotation speed is changed to a second rotation speed higher than the first rotation speed.

3. The bonding method according to claim 1, further comprising creating an adhesive space, before the placing the adhesive, by expanding center portions of the pair of substrates by moving the pair of substrates in directions that separate the center portions from each other,
wherein in the placing the adhesive, the adhesive is placed in the adhesive space.

4. The bonding method according to claim 3, wherein in the applying pressure, the moving of the pair of substrates is stopped when the thickness of the adhesive reaches a target thickness.

5. The bonding method according to claim 1, wherein the pair of substrates have flexibility.

6. The bonding method according to claim 5, wherein the pair of substrates are liquid-crystal display panels.

7. A bonding apparatus for bonding a first substrate and a second substrate together with an adhesive, the bonding apparatus comprising:
a first mounting unit on which the first substrate is mounted;
a second mounting unit on which the second substrate is mounted;
a pressure device configured to move at least one of the first mounting unit and the second mounting unit to apply pressure to the adhesive placed between the first substrate and the second substrate; and
a rotation device configured to rotate the first mounting unit and the second mounting unit.

8. The bonding apparatus according to claim 7, wherein the pressure device includes a lifting and lowering unit configured to lift and lower the second mounting unit relative to the first mounting unit.

9. The bonding apparatus according to claim 7, wherein the rotation device includes a motor and a rotary driven unit, the motor being configured to rotate the first mounting unit, the rotary driven unit being configured to support the second mounting unit such that the second mounting unit rotates to follow the rotation of the first mounting unit.

10. The bonding apparatus according to claim 7, wherein the first mounting unit includes a first base, a first sucking member configured to suck a center portion of the first substrate, and second sucking members configured to suck outer portions of the first substrate, the outer portions being outside the center portion of the first substrate; and
the second mounting unit includes a second base, a third sucking member configured to suck a center portion of the second substrate, and fourth sucking members configured to suck outer portions of the second substrate, the outer portions being outside the center portion of the second substrate.

11. The bonding apparatus according to claim 10, wherein in each of the first and second mounting units, the first sucking member and third sucking member are movable between a first height position and a second height position relative to the first base and second base, respectively, the first height position being at a height of the second sucking member and fourth sucking member, respectively, the second height position being closer to the first base and second base, respectively than the first height position is to the first base and second base, respectively.

12. The bonding apparatus according to claim 11, wherein areas of a sucking portion of the first sucking member and third sucking member are larger than areas of a sucking portion of the second sucking members and fourth sucking members.

13. The bonding apparatus according to claim 10, wherein the sucking is vacuum suction.

14. The bonding apparatus according to claim 9, wherein the rotary driven unit is a bearing attached to the pressure device and supporting the second mounting unit rotatable.
